(19) United States
(12) Patent Application Publication
(10) Pub. No.: US 2023/0396605 A1
(43) Pub. Date: Dec. 7, 2023

(54) NETWORK AUTHENTICATION SYSTEM AND NETWORK AUTHENTICATION METHOD

(71) Applicant: NIPPON TELEGRAPH AND TELEPHONE CORPORATION, Tokyo (JP)

(72) Inventors: Toshihito FUJIWARA, Musashino-shi, Tokyo (JP); Tatsuya FUKUI, Musashino-shi, Tokyo (JP); Tomohiro TANIGUCHI, Musashino-shi, Tokyo (JP); Tomohiko IKEDA, Musashino-shi, Tokyo (JP); Hiroya ONO, Musashino-shi, Tokyo (JP); Ryota SHIINA, Musashino-shi, Tokyo (JP)

(73) Assignee: NIPPON TELEGRAPH AND TELEPHONE CORPORATION, Tokyo (JP)

(21) Appl. No.: 18/032,770

(22) PCT Filed: Oct. 28, 2020
(86) PCT No.: PCT/JP2020/040445

§ 371 Date: Apr. 19, 2023

(51) Int. Cl. H04L 9/40

(52) U.S. Cl. CPC H04L 63/083

(57) ABSTRACT

An object of the present invention is to provide a network authentication system and a network authentication method capable of highly securely authenticating connection or a use place of a device without depending on a connection interface system in a mode in which a device such as audio/video equipment is directly connected to a public network. A network authentication system according to the present invention generates authentication information by a device other than a device such as audio/video equipment, and transmits the authentication information to the device as a media signal.

### TECHNICAL FIELD

The present disclosure relates to a network authentication system and a network authentication method in which a video terminal such as a camera or a monitor or an audio terminal such as a microphone or a speaker connected via a public network is authenticated.

### BACKGROUND ART

As authentication for connecting only an authorized device or user to a network, an identification (ID)/password method for performing authentication by combining an ID with a password, an electronic certificate method for exchanging electronic certificates and confirming validity thereof, and the like are known.

The ID/password method is a method in which an ID indicating a terminal or a user desired to be connected and a corresponding password are transmitted from the terminal or the user to an authentication system of a connection destination, and in a case where the password corresponding to the ID is valid in the authentication system, the connection is permitted. For example, remote authentication dial in user service (RADIUS) authentication is known as a system in which the ID/password method can be used (see, for example, Non Patent Literature 1).

Furthermore, the electronic certificate method is a method in which a certificate that is a public key of a terminal or a user desired to be connected and is signed in advance by a trusted authority such as a certificate authority is transmitted from the terminal or the user desired to be connected to an authentication system of a connection destination, the signature is verified in the authentication system, and in a case where the signature is valid, the connection is permitted. For example, an X.509 certificate or the like is known as a system in which an electronic certificate method can be used (see, for example, Non Patent Literature 2).

### CITATION LIST

### Non Patent Literature

Non Patent Literature 1: RFC 2865 “Remote Authentication Dial In User Service (RADIUS)”

Non Patent Literature 2: RFC 5280 “Internet X.509 Public Key Infrastructure Certificate and Certificate Revocation List (CRL) Profile”

### SUMMARY OF INVENTION

### Technical Problem

In the ID/password method and the electronic certificate method described above, a terminal is required to have advanced functions for authentication.

On the other hand, a mode in which audio/video equipment that is conventionally connected to a computer or the like as input/output equipment and is not assumed to be connected to a wide area public network, such as a monitor, a camera, a microphone, or a speaker, is directly connected to a public network as a terminal (device) has been studied. Audio/video equipment usually does not have above described advanced functions for authentication, and thus network authentication is difficult. Here, the audio/video equipment is not equipment using an Internet protocol (IP), but is equipment including only an interface such as a high-definition multimedia interface (HDMI, registered trademark), a displayport, a universal serial bus (USB), a sony philips digital interface (S/PDIF), a microphone terminal, or a speaker terminal.

Furthermore, in a case where dynamic authentication in a device is difficult, authentication based on a line ID or the like can also be performed using a mobile terminal or the like owned by an individual as an alternative device. For example, there is an alternative device authentication method in which a mobile terminal accesses an authentication server and obtains authentication on the basis of the line ID.

However, in the alternative device authentication method, authentication can be performed even in a case where a user is not present at a place of a physical line or a device, and there is a security issue that the device connected to the line is unintentionally used. In particular, in a case where different users need temporary authentication at different times for a shared line and a shared device, authentication need to be performed only in a case where the device connected to the line and a user are at physically close positions, but an alternative device authentication method in which a use place is restricted is difficult to be implemented.

Furthermore, in a system in which an ID and a password are manually input, the lengths of the ID and the password are likely to be short, and there is an issue that decrease in security is difficult to be prevented.

Therefore, in order to solve the above described issues, an object of the present invention is to provide a network authentication system and a network authentication method capable of highly securely authenticating connection or a use place of a device without depending on a connection interface system in a mode in which a device such as audio/video equipment is directly connected to a public network.

### Solution to Problem

In order to achieve the above described object, in a network authentication system according to the present invention, authentication information is generated by a device other than a device such as audio/video equipment, and the authentication information is transmitted to the device as a media signal.

Specifically, in a network authentication system or method according to the present invention, a video or audio device connected to a public network is authenticated by an authentication code being transmitted using a video or audio media signal that can be transmitted and received by the device.

By authentication information being transmitted using a media signal that can be transmitted and received by a used device such as audio/video equipment, a dynamic authentication system in which the device is restricted to a use place and that does not depend on a connection interface system of the device can be provided without a new device for authentication being connected to the line connecting the device. Furthermore, since authentication information is transmitted by a media signal such as a QR code (registered trademark) being automatically read, long and complicated authentication information can be included, and thus, the strength of encryption can be easily increased and the security strength can be easily increased. Furthermore, information other than ID/password information is easily added, and information including equipment information and control can be exchanged.

Therefore, the present invention can provide a network authentication system and a network authentication method capable of highly securely authenticating connection or a use place of a device without depending on a connection interface system in a mode in which a device such as audio/video equipment is directly connected to a public network.

For example, a network authentication system according to the present invention includes an authentication device, a code output device, and a code reading device, in which the code output device outputs an authentication code to the public network according to an instruction of the authentication device, the device receives the authentication code from the public network and outputs the authentication code as a media signal, the code reading device reads the authentication code from the media signal and transmits the authentication code to the authentication device via the public network or another network, and the authentication device authenticates the device in a case where an authentication code that the code output device is caused to output matches an authentication code transmitted from the code reading device.

Furthermore, a network authentication system according to the present invention includes an authentication device, a code output device, and a code reading device, in which the code output device outputs an authentication code as a media signal according to an instruction of the authentication device, the device receives the media signal, converts the media signal into a signal that can be propagated through the public network, and outputs the signal to the code reading device, the code reading device reads the authentication code from the signal from the device and transmits the authentication code to the authentication device via the public network or another network, and the authentication device authenticates the device in a case where an authentication code that the code output device is caused to output matches an authentication code transmitted from the code reading device.

Note that the inventions described above can be combined as appropriate.

### Advantageous Effects of Invention

The present invention can provide a network authentication system and a network authentication method capable of highly securely authenticating connection or a use place of a device without depending on a connection interface system in a mode in which a device such as audio/video equipment is directly connected to a public network.

### BRIEF DESCRIPTION OF DRAWINGS

FIG. 1 is a diagram illustrating a network authentication system according to the present invention.

FIG. 2 is a diagram illustrating a network authentication system according to the present invention.

FIG. 3 is a diagram illustrating a network authentication system according to the present invention.

FIG. 4 is a diagram illustrating operation of the network authentication system according to the present invention.

FIG. 5 is a diagram illustrating operation of the network authentication system according to the present invention.

FIG. 6 is a diagram illustrating functions of respective devices of the network authentication system according to the present invention.

FIG. 7 is a diagram illustrating functions of respective devices of the network authentication system according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that components having the same reference signs in the present description and the drawings indicate the same components.

### First Embodiment

In a network authentication system according to the present embodiment, a video or audio device connected to a public network is authenticated by an authentication code being transmitted using a video or audio media signal that can be transmitted and received by the device.

### (First Mode)

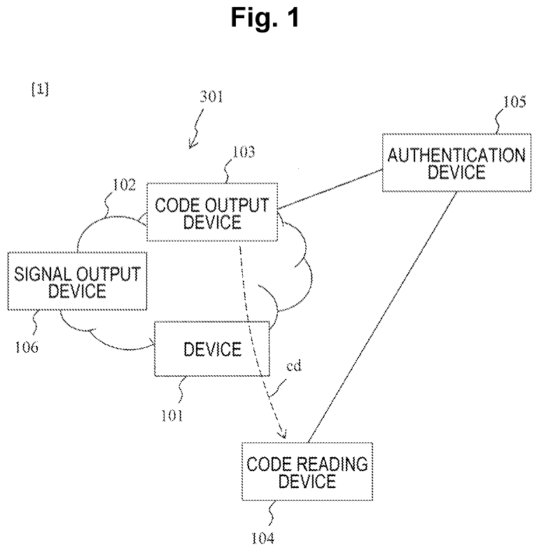

FIG. 1 is a diagram illustrating a network authentication system 301. The network authentication system 301 is an example in which a device 101 is an output device such as a monitor or a speaker. The network authentication system 301 includes an authentication device 105, a code output device 103, and a code reading device 104, in which the code output device 103 outputs an authentication code cd to a public network 102 according to an instruction of an authentication device 105, the device 101 receives the authentication code cd from the public network 102 and outputs the authentication code cd as a media signal, the code reading device 104 reads the authentication code cd from the media signal and transmits the authentication code cd to the authentication device 105 via the public network 102 or another network, and the authentication device 105 authenticates the device 101 in a case where an authentication code that the code output device 103 is caused to output matches an authentication code cd transmitted from the code reading device 104.

The device 101 is connected to the code output device 103 via the public network 102 to which the device can be directly connected. Specifically, the public network 102 is a network to which a dedicated video/audio interface such as an HDMI (registered trademark), a displayport, a USB, an S/PDIF, a microphone terminal, or a speaker terminal can be directly connected. Furthermore, in order to perform long-distance transmission, for example, a signal may be subjected to optical conversion, or packetizing or framing may be performed according to a specific procedure so that lines can be concentrated. Note that the network authentication system 301 does not prevent the device 101 from using an IP.

The code output device 103 transmits an authentication code cd to the device 101 via the public network 102 as a media signal that can be directly output by the device 101 on the basis of an instruction from the authentication device 105. The device 101 outputs the media signal. Note that the authentication code cd may be a timed code.

The code reading device 104 reads the authentication code cd from the media signal output from the device 101, and transmits a reading result to the authentication device 105. For example, the code reading device 104 transmits a reading signal or a signal obtained by decoding the reading signal to 105 as the reading result.

In a case where an authentication code that the code output device 103 is caused to output matches a code received from the code reading device 104, the authentication device 105 permits the device 101 to connect to authorized equipment other than the code output device 103. As a result, the public network 102 in which the device 101 can be connected to predetermined equipment is reconstructed. For example, after authentication, the device 101 can be connected to a signal output device 106 and output a signal from the signal output device 106.

The code reading device 104 is connected to the authentication device 105 via the public network 102 or another network. The authentication device 105 can authenticate the validity of the code reading device 104 before, after, or during authentication of the device 101.

### (Second Mode)

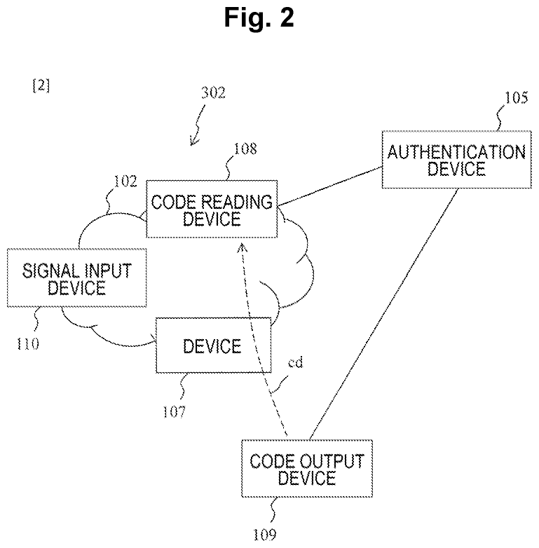

FIG. 2 is a diagram illustrating a network authentication system 302. The network authentication system 302 is an example in which a device 107 is an input device such as a camera or a microphone. The network authentication system 302 includes the authentication device 105, a code output device 109, and a code reading device 108, in which the code output device 109 outputs an authentication code cd as a media signal according to an instruction of the authentication device 105, the device 107 receives the media signal, converts the media signal into a signal that can be propagated through the public network 102, and outputs the signal to the code reading device 108, the code reading device 108 reads the authentication code cd from the signal from the device 107 and transmits the authentication code cd to the authentication device 105 via the public network 102 or another network, and the authentication device 105 authenticates the device 107 in a case where an authentication code that the code output device 109 is caused to output matches an authentication code transmitted from the code reading device 108.

The device 107 is connected to the code reading device 108 via the public network 102 to which the device can be directly connected. The public network 102 is the same as that described in FIG. 1. Furthermore, the network authentication system 302 also does not prevent the device 107 from using an IP.

The code output device 109 outputs an authentication code cd as a media signal that can be directly received by the device 107 on the basis of an instruction from the authentication device 105. Note that the authentication code may be a timed code. The device 107 reads the authentication code cd from the signal output from the code output device 109, and transmits the authentication code cd to the code reading device 108 via the public network 102. The code reading device 108 receives the authentication code cd from the public network 102, reads the authentication code cd, and transmits a reading result to the authentication device 105. For example, the code reading device 108 transmits a reading signal or a signal obtained by decoding the reading signal to the authentication device 105 as the reading result.

In a case where an authentication code cd output from the code output device 109 matches a code received from the code reading device 108, the authentication device 105 permits the device 107 to connect to authorized equipment other than the code reading device 108. As a result, the public network 102 in which the device 107 can be connected to predetermined equipment is reconstructed. For example, after authentication, the device 107 can be connected to a signal input device 110 and output a signal to the signal input device 110.

The code output device 109 is connected to the authentication device 105 via the public network 102 or another network. The authentication device 105 can authenticate the validity of the code reading device 108 before, after, or during authentication of the device 107.

### (Third Mode)

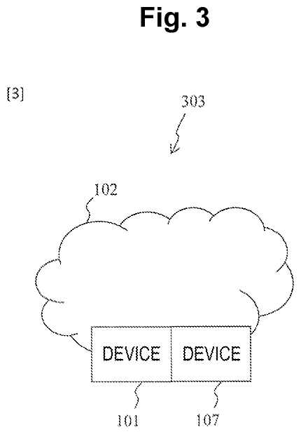

FIG. 3 is a diagram illustrating a network authentication system 303. In the network authentication system 303, a plurality of devices (the device 101 and the device 107) are integrally connected to the public network 102. The numbers of the device 101 and the device 107 to be integrated may be singular or plural. Furthermore, one of the devices may be omitted. In this case, authentication can be completed by either the authentication of the device 101 described in FIG. 1 or the authentication of the device 107 described in FIG. 2 being completed. Furthermore, each of the devices may be individually authenticated.

### (Mode of Public Network Connection)

A video interface such as an HDMI, a displayport, and a USB can be connected to the public network 102 as it is. A monitor as an output device and a camera or the like as an input device can be connected to the video interface.

An audio interface such as line input/output, microphone input, and speaker output can be connected to the public network 102 as it is, whether the audio interface is analog or digital. A speaker or a headphone as an output device or a microphone or the like as an input device can be connected to the audio interface.

A smartphone or a tablet can be used as the code reading device 104 or the code output device 109. In particular, a camera or a microphone provided to a smartphone or a tablet can be used as the code reading device 104. Furthermore, a screen of a smartphone or a provided speaker can be used as the code output device 109.

### (Mode of Authentication Code)

An authentication code cd output from the code output device (103 or 109) can include an ID of a line as it is or information obtained by encrypting the ID of the line. As a result, the code reading device (104 or 108) and the authentication device 105 can identify and authenticate the line used by the device (101 or 107) that has output or read the authentication code cd.

For example, in a case where an authentication code is a media signal (video), any code such as a QR code or a bar code can be used. Furthermore, in a case where the authentication code is a media signal (audio), either or both of an audible sound and an ultrasonic wave can be used.

### (First Network Authentication Method)

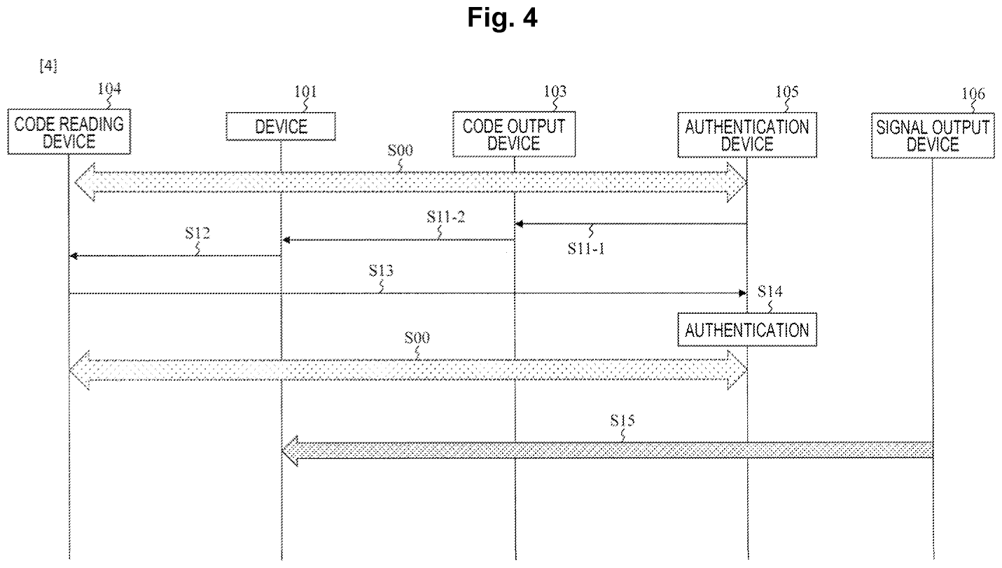

FIG. 4 is a sequence diagram illustrating a network authentication method of the network authentication system 301 described in FIG. 1. The present network authentication method includes, by the code output device 103, outputting an authentication code cd to the public network 102 according to an instruction of the authentication device 105 (step S11), by the device 101, receiving the authentication code cd from the public network 102 and outputting the authentication code cd as a media signal (step S12), by the code reading device 104, reading the authentication code cd from the media signal and transmitting the authentication code cd to the authentication device 105 via the public network 102 or another network (step S13), and, by the authentication device 105, authenticating the device 101 in a case where an authentication code that the code output device 103 is caused to output matches an authentication coded transmitted from the code reading device 104.

Step S11 includes step S11-1 and step S11-2.

In step S11-1, the authentication device 105 gives timed authentication information including line information to the code output device 103. This information can be encoded and passed. For example, assuming that line information C, timed information t, and an encoding function f are set, the sequence of authentication information e can be expressed as e=f(C,t). As a result, C that is the line ID can be concealed from the code reading device 104, and unauthorized use can be prevented.

In step S11-2, the code output device 103 processes the authentication information e into a media signal, and outputs the media signal to the device 101 via the public network 102.

In step S12, the device 101 outputs the media signal. For example, in a case where the media signal is video, the device 101 displays a QR code, a bar code, or the like on the screen. Furthermore, in a case where the media signal is audio, the device 101 modulates a sound wave and outputs the sound wave from the speaker or the like. The modulation method may be any one of FSK, PSK, ASK, QAM, OFDM, or the like. Furthermore, multi-tone may be used. Furthermore, not only an audible sound but also an ultrasonic wave can be used.

In step S13, the code reading device 104 notifies the authentication device 105 of the image obtained by reading or the sound wave itself, or information obtained by decoding the QR code or the like as a reading result. Here, an identifier of the code reading device 104 can be included as the reading result. As the identifier, a value corresponding to the line ID of the mobile terminal or the terminal ID can be used. Furthermore, the identifier may be encrypted using a public key separately obtained from the authentication device 105. Accordingly, leakage of the identifier of the code reading device 104 can be prevented.

In step S14, in a case where the code reading result is information from the valid code reading device 104, the authentication device 105 authenticates the device 101. Then, the authentication device 105 connects the device 101 to another opposite device such as the signal output device 106 (step S15).

Note that the authentication device 105 also needs to authenticate the code reading device 104 (step S00). The authentication may be performed before step S11, after step S13, or in the middle of steps S11 to S13. Furthermore, the authentication method may be any of the ID/password method, the electronic certificate method, and other methods.

Furthermore, the authentication device 105 can cancel the authentication of the device 101 and shift to a non-authentication state by detecting the end of use from a timer or a user.

### (Second Network Authentication Method)

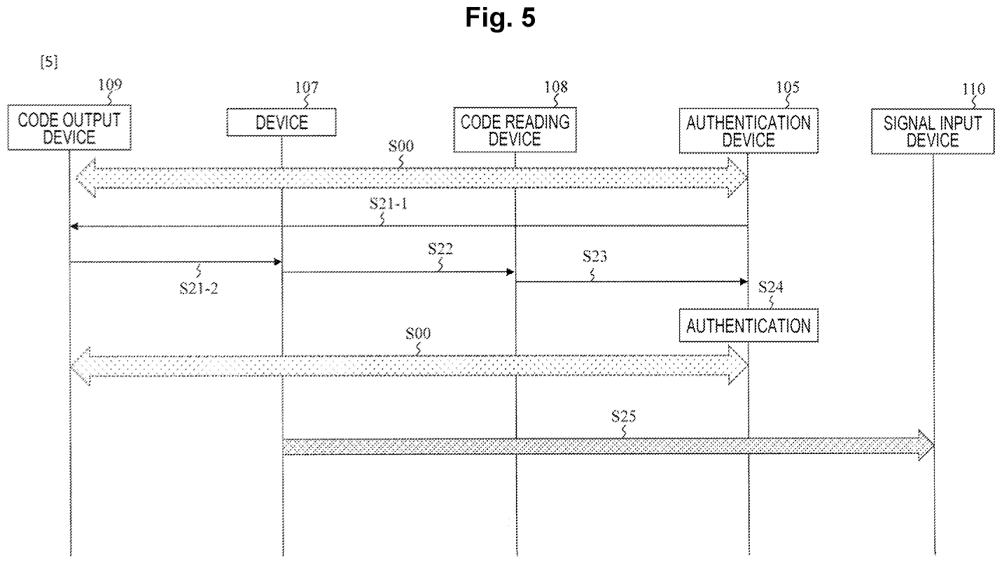

FIG. 5 is a sequence diagram illustrating a network authentication method of the network authentication system 302 described in FIG. 2. The present network authentication method includes, by the code output device 109, outputting an authentication code as a media signal according to an instruction of the authentication device 105 (steps S21-1 and S21-2), by the device 107, receiving the media signal, converting the media signal into a signal that can be propagated through the public network 102, and outputting the signal to the code reading device 108 (step S22), by the code reading device 108, reading the authentication code from the signal from the device 107 and transmitting the authentication code to the authentication device 105 via the public network 102 or another network (step S23), and, by the authentication device 105, authenticating the device 107 in a case where an authentication code that the code output device 109 is caused to output matches an authentication code transmitted from the code reading device 108 (step S24).

In step S21-1, the authentication device 105 gives timed authentication information including line information to the code output device 109. This information can be encoded and passed. For example, assuming that line information C, timed information t, and an encoding function f are set, the sequence of authentication information e can be expressed as e=f(C,t). As a result,

C that is the line ID can be concealed from the code output device 109, and unauthorized use can be prevented.

In step S12-2, the code output device 109 processes the authentication information e into a media signal, and outputs the media signal to the device 107. For example, in a case where the media signal is video, the code output device 109 displays a QR code, a bar code, or the like on the screen. Furthermore, in a case where the media signal is audio, the device 101 modulates a sound wave and outputs the sound wave from the speaker or the like. The modulation method may be any one of FSK, PSK, ASK, QAM, OFDM, or the like. Furthermore, multi-tone may be used. Furthermore, not only an audible sound but also an ultrasonic wave can be used.

Furthermore, the code output device 109 can include its own identifier in the media signal. As the identifier, a value corresponding to the line ID of the mobile terminal or the terminal ID can be used. Furthermore, the identifier may be encrypted using a public key separately obtained from the authentication device 105. Accordingly, leakage of the identifier of the code output device 109 can be prevented.

In step S22, the device 107 reads the media signal using the camera, the microphone, or the like, and outputs the information as it is to the code reading device 108 via the public network 102.

In step S23, the code reading device 108 reads the information from the device 107. Then, the code reading device 108 transfers a reading result to the authentication device 105. The reading result may be an image that the code reading device 108 has read, a sound wave, information obtained by decoding a QR code, or the like.

In step S24, in a case where the code reading result is information from the valid code output device 109, the authentication device 105 authenticates the device 107. Then, the authentication device 105 connects the device 107 to another opposite device such as the signal input device 110 (step S25).

Note that the authentication device 105 also needs to authenticate the code output device 109 (step S00). The authentication may be performed before step S21-1, after step S23, or in the middle of steps S21-1 to S23. Furthermore, the authentication method may be any of the ID/password method, the electronic certificate method, and other methods.

### (Functions of Respective Device)

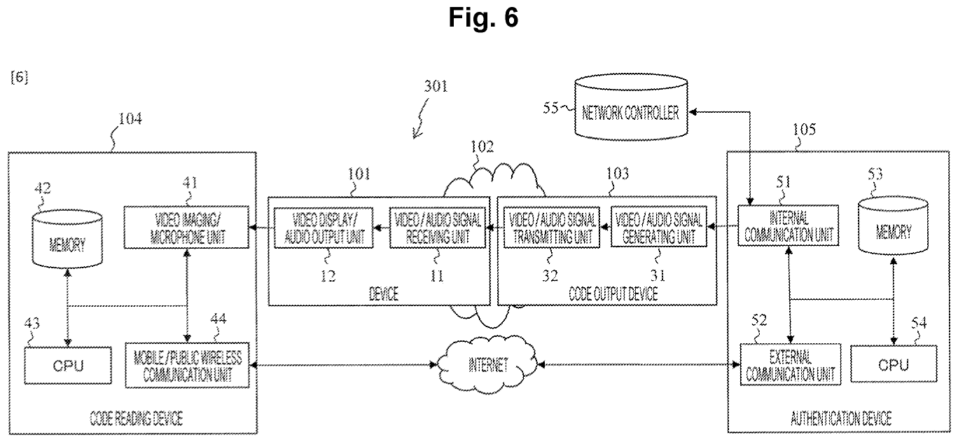

FIG. 6 is a diagram illustrating functions of respective devices of the network authentication system 301 illustrated in FIG. 1.

The code reading device 104 includes a video imaging/microphone unit 41, a memory 42, a central processing unit (CPU) 43, and a mobile/public wireless communication unit 44. The code reading device 104 is, for example, a smartphone or a tablet terminal.

The video imaging/microphone unit 41 images video output from the device 101 by a video imaging unit, and writes the contents in the memory 42. Alternatively, the video imaging/microphone unit 41 collects an audio signal output from the device 101 by a microphone, and writes the contents in the memory 42.

The CPU 43 refers to the memory 42, analyzes the contents obtained by imaging/recording, and stores the result in the memory 42. For example, the CPU 43 reads a code included in video of a QR code or the like from the video.

The mobile/public wireless communication unit 44 transmits the code that the CPU 43 has read to the authentication device 105 as a reading result. At that time, the mobile/public wireless communication unit 44 may appropriately packetize the reading result or add other information to the reading result.

The device 101 includes a video/audio signal receiving unit 11 that receives a video/audio signal from the code output device 103 via the public network 102, and a video display/audio output unit 12 that displays video or outputs audio using the signal. The device 101 is, for example, a monitor including an interface such as an HDMI or a USB. Furthermore, the device 101 is audio equipment including another audio interface.

The video/audio signal receiving unit 11 can receive an HDMI, a USB, or another video or audio interface signal.

The video display/audio output unit 12 can output a signal from the video/audio signal receiving unit 11. Specifically, the video display/audio output unit 12 can display video as a monitor or output an audio signal as a speaker.

The code output device 103 includes a video/audio signal generating unit 31 that generates a video/audio signal according to information from the authentication device 105, and a video/audio signal transmitting unit 32 that transmits the video/audio signal to the device 101 via the public network 102.

The video/audio signal transmitting unit 32 transmits an HDMI, a USB, or another video or audio interface signal.

The video/audio signal generating unit 31 generates a video signal or an audio signal from code information e from the authentication device 105. For example, the video/audio signal generating unit 31 generates an image such as a QR code from the code information e.

The authentication device 105 includes an internal communication unit 51, an external communication unit 52, a memory 53, and a CPU 54.

The CPU 54 generates code information e corresponding to a line ID and the time. Furthermore, the CPU 54 collates a code reading result from the external communication unit 52 with the code information e. In a case where the collating result is true, the CPU 54 authenticates the device 101 and communicates any control information to a network controller 55 via the internal communication unit 51. The network controller 55 connects the authenticated device 101 to another signal output device 106 or the like by the control information.

Furthermore, the CPU 54 can perform an authentication process with the code reading device 104.

When the internal communication unit 51 transmits the code information e stored in the memory 53 to the code output device 103, the internal communication unit 51 may appropriately packetize the code information e or add other information to the code information e. Furthermore, the internal communication unit 51 communicates with the network controller 55.

The external communication unit 52 receives a code reading result from the code reading device 104 and stores the code reading result in the memory 53.

The network controller 55 is a control device that forms any connection in the public network 102.

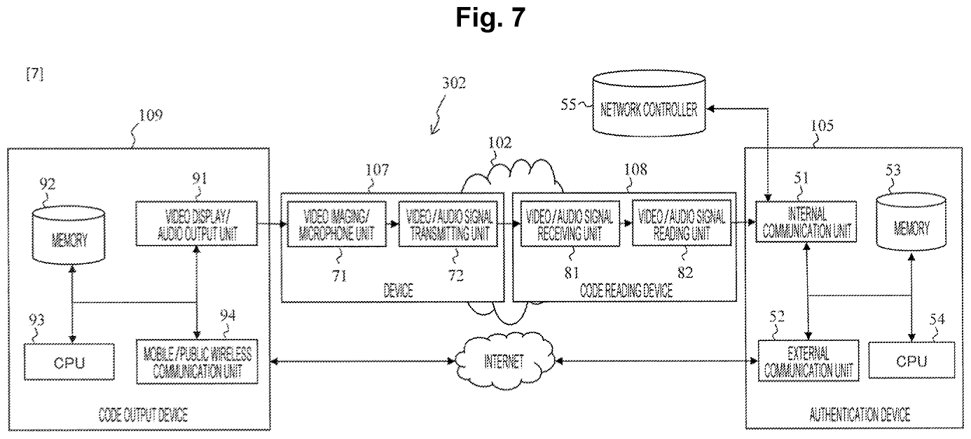

FIG. 7 is a diagram illustrating functions of respective devices of the network authentication system 302 illustrated in FIG. 2.

The code output device 109 includes a video display/audio output unit 91, a memory 92, a CPU 93, and a mobile/public wireless communication unit 94. The code output device 109 is, for example, a smartphone or a tablet terminal.

The mobile/public wireless communication unit 94 receives code information e from the authentication device 105.

The CPU 93 generates a video signal or an audio signal from the code information e. For example, the CPU 93 can generate an image such as a QR code from the code information e and store the image in the memory 92.

The video display/audio output unit 91 can read information from the memory 92 and output a signal. Specifically, the video display/audio output unit 91 can display video as a monitor or output an audio signal as a speaker.

The device 107 includes a video imaging/microphone unit 71 that reads a video/audio signal from the code output device 109, and a video/audio signal transmitting unit 72 that transmits the video/audio signal to the code reading device 108 via the public network 102. The device 107 is, for example, a camera including an interface such as an HDMI or a USB, or audio equipment including another audio interface.

The video imaging/microphone unit 71 images video from the code output device 109 by a video imaging unit or collects an audio signal from the code output device 109 by a microphone.

The video/audio signal transmitting unit 72 transmits a signal from the video imaging/microphone unit 71 as an HDMI, a USB, or another video or audio interface signal.

The code reading device 108 includes a video/audio signal receiving unit 81 that receives a video/audio signal from the device 107 via the public network 102, and a video/audio signal reading unit 82 that reads information from the video/audio signal.

The video/audio signal receiving unit 81 transmits an HDMI, a USB, or another video or audio interface signal.

The video/audio signal reading unit 82 reads a code from the signal from the video/audio signal receiving unit 81 and outputs the code as a reading result. For example, the video/audio signal reading unit 82 reads a code from video of a QR code or the like.

The authentication device 105 includes an internal communication unit 51, an external communication unit 52, a memory 53, and a CPU 54.

The CPU 54 generates code information e corresponding to a line ID and the time. Furthermore, the CPU 54 collates a code reading result from the external communication unit 52 with the code information e. In a case where the collating result is true, the CPU 54 authenticates the device 107 and communicates any control information to a network controller 55 via the internal communication unit 51. The network controller 55 connects the authenticated device 107 to another signal input device 110 or the like by the control information.

Furthermore, the CPU 54 can execute an authentication process with the code output device 109.

When the external communication unit 52 transmits the code information e stored in the memory 53 to the code output device 109, the external communication unit 52 may appropriately packetize the code information e or add other information to the code information e.

The internal communication unit 51 receives a code reading result from the code reading device 108 and stores the code reading result in the memory 53. Furthermore, the internal communication unit 51 communicates with the network controller 55.

The network controller 55 is a control device that forms any connection in the public network 102.

### (Summary of Invention)

The above mentioned network authentication system (301 to 303) has the following features.

In a system in which a video terminal such as a camera or a monitor or an audio terminal such as a microphone or a speaker (the device 101 or 107) is connected via the public network 102, the terminal itself has no authentication function, and thus a new authentication method that does not depend on the connection interface method of the equipment is required. Note that the public network in the present specification means a line network shared by users that is provided in a wide area by a communication company or the like for connecting users in general remote places including individuals and corporates (the network is, for example, an access network).

Therefore, in the present network authentication system (301 to 303), authentication information is transmitted using a media signal itself, a mobile terminal (the code reading device 104 or the code output device 109) is combined, and authentication is performed. As a result, dynamic authentication restricted to the place where the device (101 or 107) is installed can be provided without a new device other than the device (101 or 107) being connected to the line used by the audio/video equipment (specifically, the public network 102).

Furthermore, in the present network authentication system (301 to 303), the strength of encryption is easily increased and security can be enhanced by a QR code or the like being automatically read and authentication information being transmitted. Furthermore, information other than ID/password information is easily added, and information including equipment information and control can be exchanged.

### REFERENCE SIGNS LIST

11 Video/audio signal receiving unit
12 Video display/audio output unit
31 Video/audio signal generating unit
32 Video/audio signal transmitting unit
41 Video imaging/microphone unit
42 Memory
43 CPU
44 Mobile/public wireless communication unit
51 Internal communication unit
52 External communication unit
53 Memory
54 CPU
55 Network controller
71 Video imaging/microphone unit
72 Video/audio signal transmitting unit
81 Video/audio signal receiving unit
82 Video/audio signal reading unit
91 Video display/audio output unit
92 Memory
93 CPU
94 Mobile/public wireless communication unit
101 Device
102 Public network
103 Code output device
104 Code reading device
105 Authentication device
106 Signal output device
107 Device
108 Code reading device
109 Code output device
110 Signal input device
301 to 303 Network authentication device

1. A network authentication system in which a video or audio device connected to a public network is authenticated by an authentication code being transmitted using a video or audio media signal that can be transmitted and received by the device.

2. The network authentication system according to claim 1 comprising:
an authentication device;
a code output device; and
a code reading device,
wherein
the code output device outputs an authentication code to the public network according to an instruction of the authentication device,
the device receives the authentication code from the public network and outputs the authentication code as a media signal,
the code reading device reads the authentication code from the media signal and transmits the authentication code to the authentication device via the public network or another network, and
the authentication device authenticates the device in a case where an authentication code that the code output device is caused to output matches an authentication code transmitted from the code reading device.

3. The network authentication system according to claim 1 comprising:
an authentication device;
a code output device; and
a code reading device,
wherein
the code output device outputs an authentication code as a media signal according to an instruction of the authentication device,
the device receives the media signal, converts the media signal into a signal that can be propagated through the public network, and outputs the signal to the code reading device,
the code reading device reads the authentication code from the signal from the device and transmits the authentication code to the authentication device via the public network or another network, and
the authentication device authenticates the device in a case where an authentication code that the code output device is caused to output matches an authentication code transmitted from the code reading device.

4. A network authentication method in which a video or audio device connected to a public network is authenticated by an authentication code being transmitted using a video or audio media signal that can be transmitted and received by the device.

5. The network authentication method according to claim 4 comprising:
by a code output device, outputting an authentication code to the public network according to an instruction of an authentication device;
by the device, receiving the authentication code from the public network and outputting the authentication code as a media signal;
by a code reading device, reading the authentication code from the media signal and transmitting the authentication code to the authentication device via the public network or another network; and
by the authentication device, authenticating the device in a case where an authentication code that the code output device is caused to output matches an authentication code transmitted from the code reading device.

6. The network authentication method according to claim 4 comprising:
by a code output device, outputting an authentication code as a media signal according to an instruction of an authentication device;
by the device, receiving the media signal, converting the media signal into a signal that can be propagated through the public network, and outputting the media signal to the code reading device;
by a code reading device, reading the authentication code from the signal from the device and transmitting the authentication code to the authentication device via the public network or another network; and
by the authentication device, authenticating the device in a case where an authentication code that the code output device is caused to output matches an authentication code transmitted from the code reading device.
